(19) United States
(12) Patent Application Publication
(10) Pub. No.: US 2026/0252586 A1
(43) Pub. Date: Aug. 27, 2026

(54) Multi-Nodal Hierarchical Framework for Dynamic Requirement Determination

(71) Applicant: John Patrick Stewart, Miami, FL (US)

(72) Inventor: John Patrick Stewart, Miami, FL (US)

(21) Appl. No.: 19/540,742

(22) Filed: Feb. 15, 2026

Related U.S. Application Data
(60) Provisional application No. 63/761,859, filed on Feb. 21, 2025.

(51) Int. Cl. G06F 16/28; G06F 16/22; G06F 16/2455

(52) U.S. Cl. CPC G06F 16/282; G06F 16/2246; G06F 16/24558

(57) ABSTRACT

A computer-implemented system and method for dynamic requirement determination using multiple independent hierarchy data structures. Entity records store identifiers of associated nodes in at least two hierarchies. Requirement rules define Boolean expressions, including AND, OR, and NOT operators, that reference node identifiers across multiple hierarchies. The system evaluates the Boolean expressions against an entity record's node identifiers to determine applicable requirements, generates a compliance status, and automatically re-evaluates at least a subset of the requirement rules to update applicability responsive to change events including changes in entity-node associations, hierarchy structure, or rule definitions. Requirement rules assigned to parent nodes are automatically inherited by descendant nodes, and the hierarchy data structures support recursive expansion without requiring modification to existing requirement rules. In some implementations, a control hierarchy stores condition-state values derived from external inputs such as equipment failures, environmental hazards, or regulatory changes, and triggers event-driven updates to requirement applicability in real time. A reporting engine may generate cross-dimensional compliance matrices by independently filtering entity records and requirement objects using node-based criteria across the hierarchies.

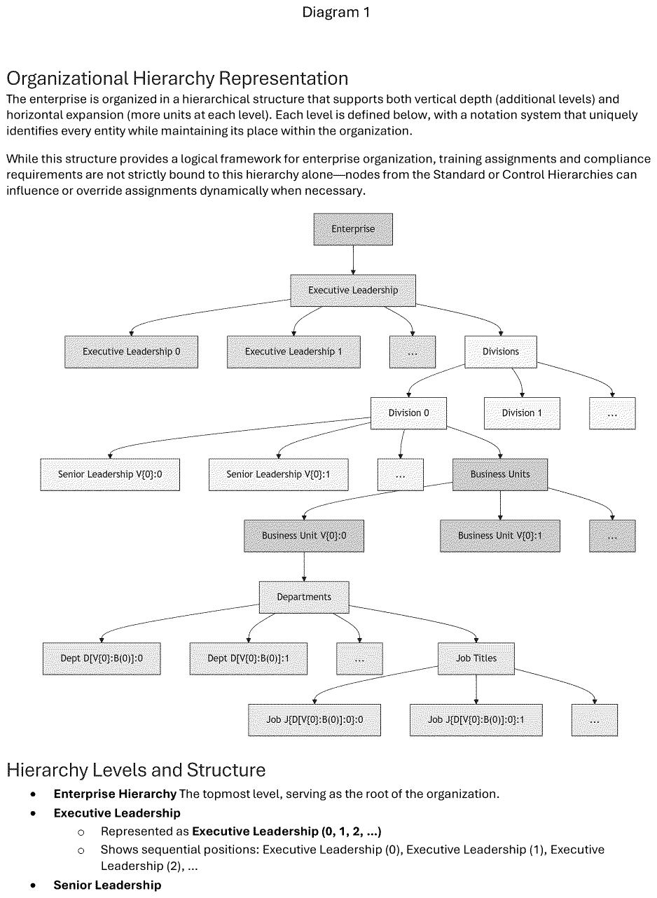

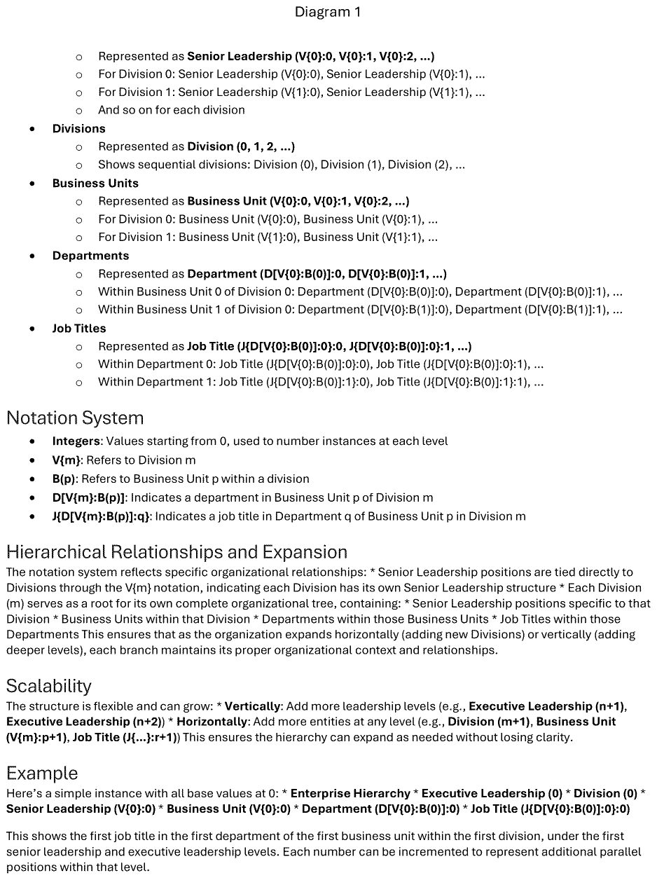

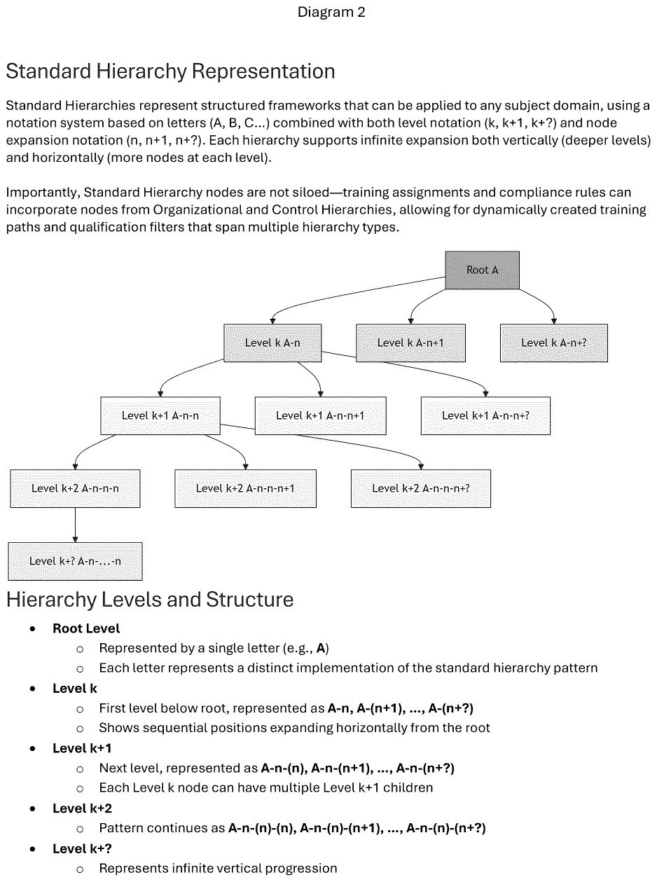

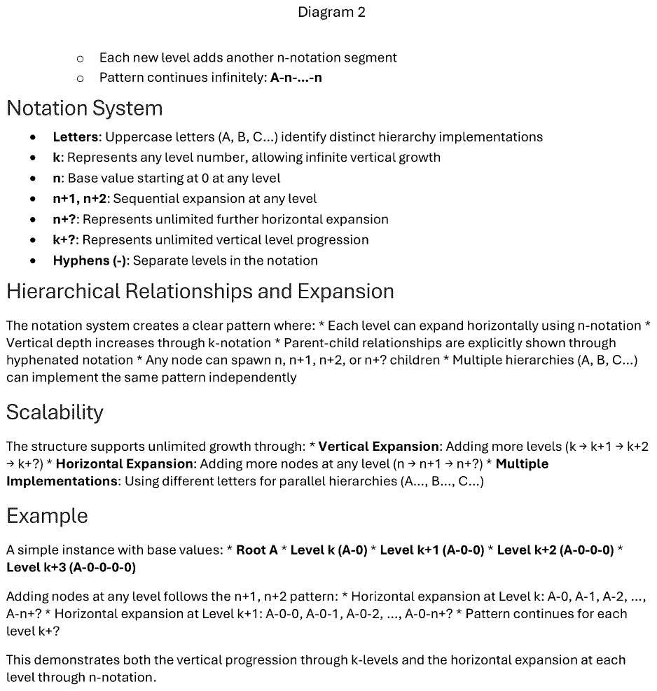

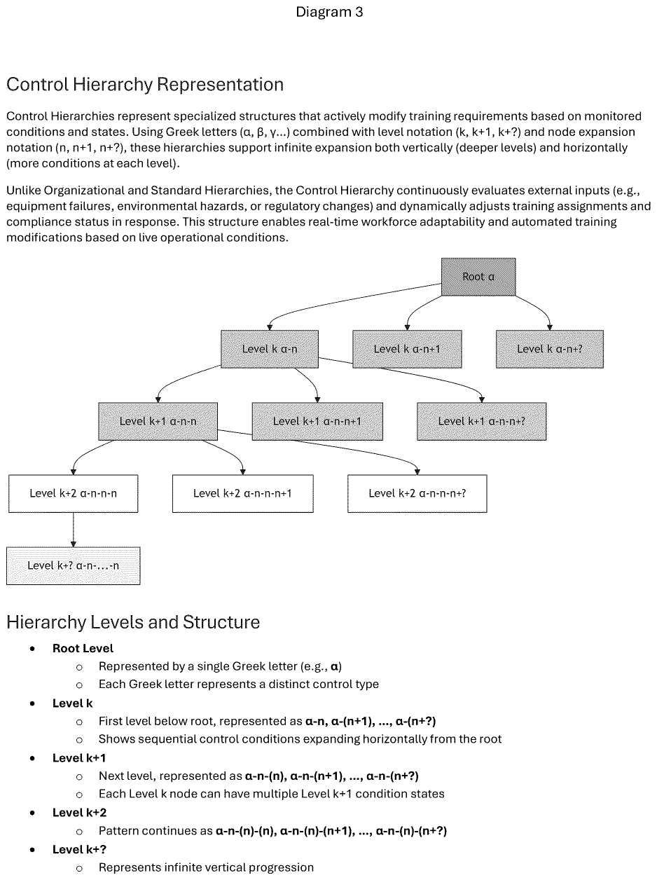

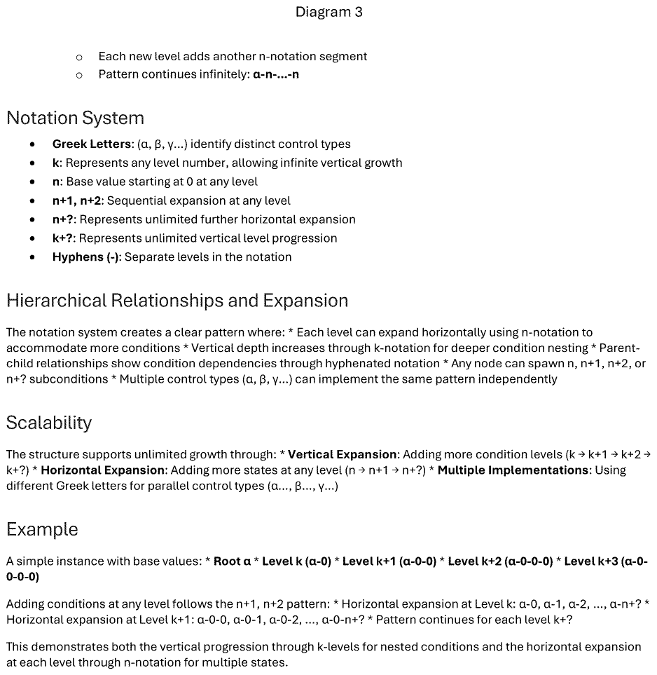

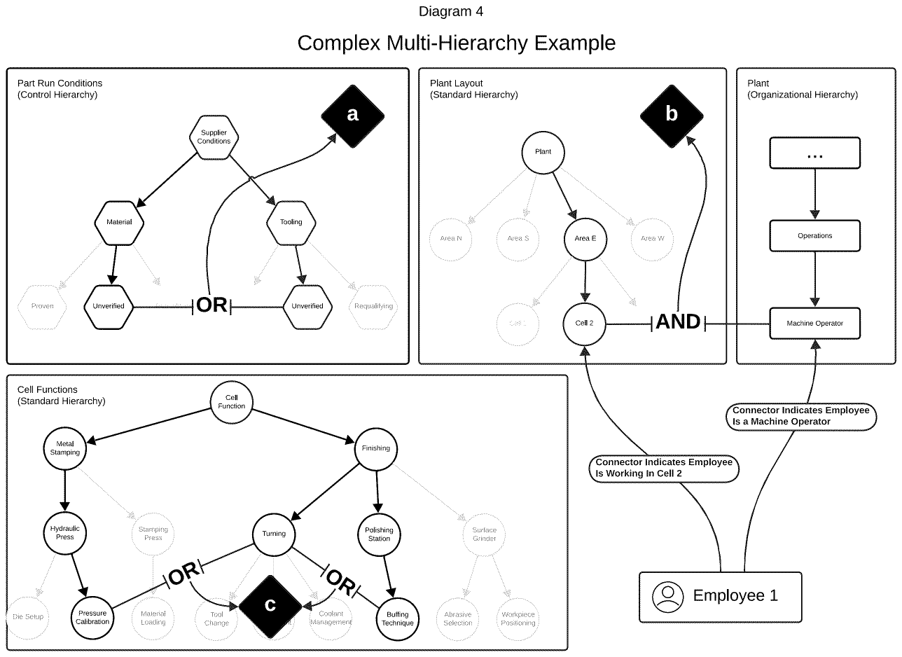

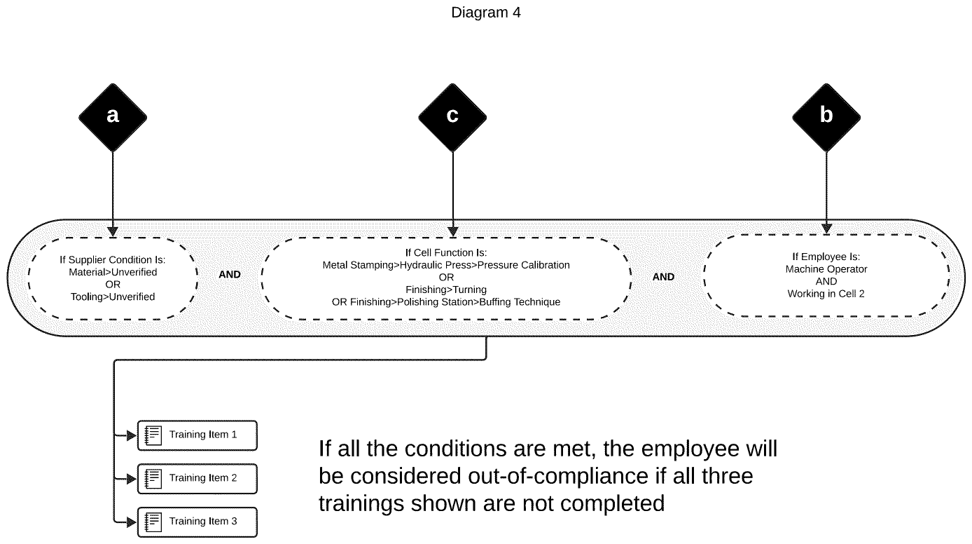

### 1. FIELD OF INVENTION

This invention pertains to software-based hierarchical systems for structured requirement management, specifically a multi-hierarchical framework that dynamically assigns, filters, and modifies structured requirements in real time. While primarily applied to training management, the framework is extensible to regulatory compliance, equipment certification, workforce qualification tracking, and other requirement-based workflows.

### 2. BACKGROUND OF THE INVENTION

### 2.1 Problems with Existing Systems

Current requirement management systems, particularly in training compliance, exhibit several limitations:

1. Rigid Hierarchical Assignments: Traditional systems rely on static job titles, departments, or single-level training groups to assign requirements, limiting adaptability and cross-functional training pathways.

2. Limited Filtering and Querying: Existing solutions do not allow for dynamic, multi-hierarchy filtering based on complex attributes like skills, location, equipment access, or real-time conditions (e.g., environmental hazards, safety triggers).

3. Lack of Real-Time Adaptation: Most platforms do not modify requirements based on real-time external conditions (e.g., safety hazards, equipment failures, regulatory changes). This leads to delays in updates and compliance gaps. For example, in a chemical plant, a static system might fail to update training requirements promptly after a regulatory change, resulting in a 3-month compliance gap.

### 2.2 The Need for a New Approach

A more flexible system is required that:
Allows Boolean-based node grouping across multiple hierarchical structures.
Supports real-time requirement modification triggered by external events (e.g., spills, equipment failures, regulatory updates).
Extends beyond training to broader requirement-based workflows (compliance, certifications, workforce management).

### 3. SUMMARY OF THE INVENTION

This invention provides a multi-hierarchical framework that dynamically assigns, filters, and modifies structured requirements using Boolean-based node grouping across Organizational, Standard, and Control Hierarchies. It enables requirement assignment and compliance validation across Organizational and Standard nodes, with an optional Control Hierarchy for real-time modifications based on external triggers. While optimized for training management, the framework applies to regulatory compliance, equipment certification, and other requirement-based workflows.

Key features include:

1. Multi-Hierarchy Boolean-Based Node Grouping: Nodes from all hierarchies can be combined with AND, OR, NOT logic for requirement assignment and evaluation.

2. Dynamic Filtering & Compliance Checks: Supports complex queries beyond job titles, identifying eligibility across hierarchies.

3. Real-Time Modifications via Control Hierarchy: Adjusts requirements instantly based on external conditions. For instance, if a chemical spill is detected, employees in the affected zone are marked out of compliance until completing emergency response training.

4. Extensibility: Adapts to non-training workflows like compliance or certification tracking.

### 4. DETAILED DESCRIPTION OF THE INVENTION

### 4.1 Multi-Hierarchy Structure

The system organizes requirements, training items, and compliance conditions into three interrelated hierarchies:

Organizational Hierarchy (Supported by Diagram 1): Represents a structured enterprise framework, mapping roles and reporting structures (Enterprise, Senior Leadership, Divisions (V), Business Units (B), Departments (D), Job Titles (J)). Each level uses n notation (n, n+1, n+?). While this structure defines traditional role-based training paths, it is not restrictive—nodes from the Standard or Control Hierarchies can dynamically influence assignments for greater adaptability.

Standard Hierarchy (Supported by Diagram 2): Uses uppercase letters (A, B, C . . . ) to represent structured frameworks (skills, competencies, equipment certifications, etc.). Each node can expand vertically with k, k+1, k+? or horizontally with n, n+1, n+?. While this hierarchy offers structured learning paths, assignments and compliance checks, it can also integrate nodes from the Organizational or Control Hierarchies, creating flexible, cross-hierarchy requirements.

Control Hierarchy (Supported by Diagram 3): A dynamic system that modifies requirements in real time based on external conditions (e.g., safety triggers, environmental hazards, regulatory updates). Using Greek letters (α, β, γ . . . ), it can expand both vertically with k, k+1, k+? and horizontally with n, n+1, n+?. Unlike the other hierarchies, Control nodes are event-driven and can override or augment training assignments from the Organizational or Standard Hierarchies.

### 4.2 Boolean-Based Node Grouping

Nodes from Organizational, Standard, and Control Hierarchies can be combined with AND, OR, NOT to define training rules, compliance checks, or eligibility filters.

### Example: Defining Training Requirements with Multi-Hierarchy Conditions

A requirement for Advanced Equipment Handling is assigned if an employee meets any of:
1. Works in “Chemical Processing” (Organizational)
2. Operates classified hazardous equipment (Standard)
3. Control Hierarchy flags the area for safety updates due to an environmental alert

This flexibility allows complex requirement definitions across hierarchies. Training requirements are evaluated dynamically based on role and hierarchy position, not statically assigned to individuals.

### 4.3 Dynamic Filtering & Qualification Checking

Complex, cross-hierarchy queries go beyond job titles or single-level structures:

### Case: Identifying Qualified Machine Operators.

Must be in the “Machine Operator” role (Organizational)
Assigned to Night Shift (Employee Attribute)
Certified for Warehouse X (Standard)

This system unlocks new possibilities, such as finding employees who can fill a role even if not assigned, or verifying compliance across different departmental or skill-based structures. Training requirements are evaluated dynamically based on role and hierarchy position, not statically assigned to individuals.

### 4.4 Control Hierarchy for Real-Time Modifications

Unlike static training assignments, the Control Hierarchy adjusts requirements immediately when triggered by external conditions:

### Example: Emergency Response Training

An environmental sensor detects a chemical spill.
Employees who have worked in the affected zone within the last 7 days are marked out of compliance until they complete an emergency response module.
Supervisors of that zone are also flagged for refresher training.
Regulatory triggers might automatically mandate additional safety certifications.

This real-time approach ensures workforce adaptability, closing compliance gaps swiftly.

### 4.5 Complex Multi-Hierarchy Example (Diagram 4)

In more complex scenarios, multiple conditions from each hierarchy interact with Boolean logic. For example:
Organizational: The employee is a Machine Operator assigned to Operations.
Standard 1 (Plant Layout): The employee is assigned to Plant Layout→Area E→Cell 2.
Standard 2 (Cell Functions): This hierarchy covers processes and sub-processes within a given cell, which might house multiple near-identical machines that share a baseline training requirement. However, certain specialized tasks (e.g., Hydraulic Press→Pressure Calibration, Finishing→Polishing Station→Buffing Technique, Finishing→Turning) may require additional training on top of that baseline, ensuring each distinct function is adequately covered.
Control: Supplier Condition or Tooling may be “Unverified.”
Training Items: T1, T2, T3 become required if these conditions align.

A pseudo-code representation clarifies how these conditions interact:

```
IF (
    (SupplierCondition = “Unverified” OR Tooling = “Unverified”)
  AND (Employee = “Machine Operator” AND “Cell 2” IS ASSIGNED)
  AND (
```

(Cell Functions: Metal Stamping → Hydraulic Press → Pressure

Calibration)

OR (Cell Functions: Finishing → Turning)
OR (Cell Functions: Finishing → Polishing Station → Buffing

```
Technique)
    )
)
THEN
  Employee is out-of-compliance unless they complete:
```

| | |
|---|---|
| - | Training Item 1 |
| - | Training Item 2 |
| - | Training Item 3 |

Explanation: The Control Hierarchy triggers additional requirements if supplier or tooling is “Unverified.” The Organizational Hierarchy identifies the employee as a Machine Operator under Operations. Standard 1 (Plant Layout) directly assigns the employee to Area E→Cell 2. Standard 2 (Cell Functions) applies tasks or processes (e.g., Hydraulic Press, Polishing) to which employees or training can be linked. If all conditions meet (Boolean AND/OR logic), the system marks the employee out-of-compliance until T1, T2, T3 are completed.

### 4.6 Example Use Case: Manufacturing Compliance

### Scenario Overview

Consider a multinational manufacturing entity, referred to herein as GlobalTech Manufacturing, employing over 12,000 individuals across three primary divisions: United States, Europe, and Asia-Pacific. Within the United States Division, the Northeast Region Business Unit oversees five operational plants located in Vermont, New Hampshire, and Maine. These facilities specialize in producing abrasive air filtration systems for industrial applications, necessitating compliance with state-specific environmental and occupational safety regulations. These regulations are subject to frequent updates, varying by jurisdiction, and must be systematically integrated into training requirements for designated personnel, such as Department Safety Coordinators, who ensure compliance at each plant.

The complexity of this scenario arises from the need to manage a large workforce across multiple plants while adapting to dynamic regulatory changes. For instance, a new Vermont air quality regulation requires immediate training updates for relevant employees. Conventional systems often lack the scalability and efficiency to propagate such changes seamlessly across the Northeast Region's organizational and regulatory framework. The multi-hierarchical framework described herein, leveraging the Standard Hierarchy and Boolean-based node grouping, is implemented by GlobalTech Manufacturing to address this complexity effectively without reliance on additional control mechanisms.

### Multi-Hierarchy Structure in Application

The framework organizes GlobalTech's compliance and training requirements through two primary hierarchies in this example:

### Organizational Hierarchy

### Structure:

Root Level: United States Division
Level 1: Northeast Region Business Unit
Level 2: Plants (e.g., Vermont Plant 1, Vermont Plant 2, New Hampshire Plant 1)
Level 3: Departments (e.g., Abrasive Processing, Quality Control)
Level 4: Job Titles (e.g., Department Safety Coordinator)

Notation Example: A Department Safety Coordinator in Vermont Plant 1 is represented as J{D[V0:B0]:P0:D0}:0, where V0 denotes the United States Division, B0 denotes the Northeast Region Business Unit, P0 denotes Vermont Plant 1, DO denotes the Abrasive Processing Department, and J0 denotes the first Safety Coordinator position.

Functionality: This hierarchy establishes the organizational context, enabling precise identification of employees subject to training requirements based on their roles and locations.

### Standard Hierarchy (State Regulations)

Structure: This hierarchy categorizes state-specific regulations related to abrasive air filtration, utilizing uppercase letters to denote regulatory domains.
   Root Level: A (Environmental and Safety Regulations)
   Level k: State Codes (e.g., A-0=Vermont, A-1=New Hampshire, A-2=Maine)
   Level k+1: Regulation Categories (e.g., A-0-0=Air Quality, A-0-1=Machinery Safety)
   Level k+2: Specific Codes (e.g., A-0-0-0=Vermont Air Quality Code 4.4.1)

Predefined Grouping: The node A-0-0 (Vermont Air Quality) is associated with a Boolean condition targeting employees within the Organizational Hierarchy:

IF (Employee IN Organizational Node “Vermont.Department Safety
Coordinator”)
THEN Require Training for Compliance

This rule extends to all sub-nodes under A-0-0.

Functionality: The hierarchy systematically organizes regulations, supporting infinite scalability by accommodating additional codes (e.g., A-0-0-1) and linking them to training modules that propagate automatically to employees meeting predefined criteria.

### Operational Example

On Feb. 1, 2025, Vermont enacts “Vermont Environmental Code 4.4.1”, imposing stricter dust emission limits for abrasive air filtration systems. Compliance mandates that all Department Safety Coordinators in Vermont plants complete a training module, designated as T1: Abrasive Dust Mitigation Techniques, within 30 days. The framework processes this requirement as follows:

Regulation Incorporation: The new regulation is added to the Standard Hierarchy as a sub-node under Vermont Air Quality, represented as A-0-0-1. The training module T1 is linked to this node.

Automatic Propagation: Because A-0-0 (the parent node) is already tied to the Boolean condition, the addition of A-0-0-1 inherits this grouping. The system instantly evaluates:

IF (Employee IN Organizational Node “Vermont.Department Safety
Coordinator”)
THEN Require Training T1 for Compliance

This identifies 15 Safety Coordinators across Vermont Plant 1 (e.g., J{D[V0:B0]:P0:D0}:0) and Vermont Plant 2 as needing T1 for compliance.

Compliance Evaluation: When compliance is assessed (e.g., via reports or displays), the system checks these coordinators' records against T1. Those who haven't completed it are marked “out-of-compliance” until the requirement is met.

Scalability in Practice: One week later, New Hampshire enacts “New Hampshire Occupational Safety Code 7.2.3: Filter Maintenance Protocols”, added as A-1-1-0 under A-1-1 (New Hampshire Machinery Safety). A predefined rule for “New Hampshire. Department Safety Coordinator” establishes T2: Filter Maintenance as a compliance requirement for 10 coordinators in New Hampshire Plant 1, demonstrating the hierarchy's ability to scale and adapt seamlessly.

### Technical Advantages

Scalability: The Standard Hierarchy accommodates a growing set of regulations and training requirements across multiple states, integrating new nodes without structural redesign, making it suitable for large-scale operations.

Efficiency: Boolean-based node grouping ensures that training requirements propagate instantly upon node addition, with compliance evaluated dynamically, eliminating the need to manage static assignments.

Flexibility: The system links regulations to specific employee roles dynamically, adapting to jurisdictional and role changes while maintaining precision in requirement determination.

### Relevance to the Invention

This example highlights the Standard Hierarchy's critical role in managing complex, dynamic datasets within a manufacturing context, in conjunction with the Organizational Hierarchy. By organizing regulations hierarchically and leveraging predefined Boolean conditions, the framework efficiently determines and evaluates training requirements for thousands of employees across diverse locations, demonstrating its technical utility and scalability independent of additional control structures.

### 5. BENEFITS

### 5.1 Enhanced Flexibility and Adaptability

The multi-hierarchical framework allows requirements to be assigned and modified dynamically. By integrating Organizational, Standard, and Control Hierarchies with Boolean-based node grouping, the system adapts quickly to changing conditions, ensuring that training and compliance requirements are always current.

### 5.2 Real-Time Responsiveness

With its built-in Control Hierarchy, the invention can automatically adjust to external triggers such as environmental hazards or regulatory changes. This real-time modification capability minimizes compliance gaps and ensures that necessary updates are implemented without delay.

### 5.3 Cross-Functional Integration

The framework transcends traditional, static role assignments by allowing dynamic grouping and filtering across multiple hierarchies. This integration facilitates more accurate identification of qualified personnel, even in complex or shifting organizational environments.

### 5.4 Scalability and Extensibility

The system is designed to grow with an organization. Whether applied to training management, regulatory compliance, or workforce certification, the framework can accommodate increasing complexity without loss of clarity or efficiency.

### 5.5 Streamlined Administration

By consolidating requirement management into a single, coherent system, administrative overhead is reduced. This simplification not only eases auditing and reporting but also improves overall operational efficiency.

### 6. DIAGRAMS

Diagram 1: Organizational Hierarchy Representation
Diagram 2: Standard Hierarchy Representation
Diagram 3: Control Hierarchy Representation
Diagram 4: Complex Multi-Hierarchy Example
   Shows how multiple conditions from Organizational, Standard, and Control Hierarchies converge.
   Demonstrates pseudo-code for combining these conditions (Boolean AND/OR) to trigger multiple training items.

1. A computer-implemented system for dynamic requirement evaluation, comprising:
(a) at least one processor;
(b) a non-transitory computer-readable memory storing instructions that, when executed by the at least one processor, cause the system to:
(i) maintain, in at least one data store, a plurality of hierarchy data structures, each hierarchy data structure comprising nodes and parent-child relationships defining a hierarchy for a corresponding classification dimension, wherein each hierarchy data structure is maintained independently of every other hierarchy data structure, the parent-child relationships of one hierarchy data structure do not define parent-child relationships of another hierarchy data structure, and each hierarchy data structure may be modified, expanded, or restructured without requiring corresponding changes to any other hierarchy data structure;
(ii) maintain a plurality of entity records, each entity record storing identifiers of one or more associated nodes in at least two of the plurality of hierarchy data structures;
(iii) maintain a plurality of requirement rules, each requirement rule comprising a Boolean expression that includes node membership conditions referencing node identifiers from at least two of the plurality of hierarchy data structures and at least one logical operator selected from AND, OR, and NOT; and
(iv) for an entity record, evaluate the Boolean expressions against the node identifiers stored in the entity record to determine a set of requirements applicable to the entity record.

2. The system of claim 1, wherein the instructions further cause the system to:
(a) generate a compliance status for the entity record based on whether the entity record has satisfied each requirement in the determined set of applicable requirements; and
(b) responsive to detecting a change event comprising at least one of (i) a change to a node identifier stored in an entity record, (ii) a change to a node or parent-child relationship in at least one hierarchy data structure, or (iii) a requirement rule being added or modified, automatically re-evaluate at least a subset of the plurality of requirement rules to update the set of applicable requirements and the compliance status, without requiring manual intervention.

3. A computer-implemented method for dynamically determining requirements applicable to entities, the method comprising:
(a) maintaining a plurality of hierarchy data structures, each hierarchy data structure comprising nodes and parent-child relationships defining a hierarchy for a corresponding classification dimension, wherein each hierarchy data structure is maintained independently of every other hierarchy data structure, and each hierarchy data structure may be modified, expanded, or restructured without requiring corresponding changes to any other hierarchy data structure;
(b) storing, for each entity of a plurality of entities, an entity record that includes identifiers of one or more nodes in at least two of the plurality of hierarchy data structures;
(c) storing a plurality of requirement rules, each requirement rule comprising a Boolean expression that includes node membership conditions referencing node identifiers from at least two of the plurality of hierarchy data structures and at least one logical operator selected from AND, OR, and NOT;
(d) evaluating, for an entity record, the Boolean expressions of the plurality of requirement rules against node identifiers stored in the entity record to determine a set of requirements applicable to the entity;
(e) generating a compliance status for the entity based on whether the entity has satisfied each requirement in the determined set of applicable requirements; and
(f) responsive to detecting a change event comprising at least one of (i) a change to a node identifier stored in an entity record, (ii) a change to a node or parent-child relationship in at least one hierarchy data structure, or (iii) a requirement rule being added or modified, automatically re-evaluating at least a subset of the plurality of requirement rules to update the set of applicable requirements and the compliance status.

4. A non-transitory computer-readable medium storing instructions that, when executed by at least one processor of a computer system, cause the computer system to perform the method of claim 3.

5. A computer-implemented system for event-driven modification of requirement applicability, comprising:
(a) at least one processor;
(b) a non-transitory computer-readable memory storing instructions that, when executed by the at least one processor, cause the system to:
(i) maintain a first set of one or more hierarchy data structures defining organizational attributes of entities, and a second set of one or more hierarchy data structures defining standards, competencies, or qualification frameworks;
(ii) maintain a control hierarchy data structure comprising nodes representing monitorable conditions, wherein each node in the control hierarchy data structure is associated with a stored condition-state value derived from an external input;
(iii) maintain a plurality of entity records, each entity record storing identifiers of one or more associated nodes across the first set, second set, and control hierarchy data structures;
(iv) maintain a plurality of requirement rules, each requirement rule comprising a Boolean expression that includes node membership conditions referencing node identifiers from at least the control hierarchy data structure and at least one of the first set or second set of hierarchy data structures, and at least one logical operator selected from AND, OR, and NOT;
(v) responsive to receiving an external input indicating a change in a monitored condition, update the stored condition-state value of one or more nodes in the control hierarchy data structure;
(vi) responsive to the updating of the stored condition-state value, automatically re-evaluate the requirement rules that reference the affected control hierarchy nodes against entity records to determine modified requirement applicability for affected entities; and
(vii) generate an updated compliance status for each affected entity reflecting the modified requirement applicability, wherein the control hierarchy can override or augment requirement applicability defined by the first set or second set of hierarchy data structures without requiring modification to those hierarchy data structures.

6. The system of claim 1, wherein the plurality of hierarchy data structures comprises:
(i) an organizational hierarchy defining roles, reporting structures, divisions, business units, departments, and job titles;
(ii) at least one standard hierarchy defining a structured framework of standards, competencies, certifications, or regulatory requirements; and
(iii) a control hierarchy defining monitorable condition states that are updatable based on external inputs, wherein the control hierarchy dynamically modifies requirement applicability based on changes to the external inputs.

7. The system of claim 6, wherein the organizational hierarchy comprises a plurality of levels including at least an enterprise level, a division level, a business unit level, a department level, and a job title level, and wherein each level is configured to support horizontal expansion to accommodate additional organizational units at the level.

8. The system of claim 6, wherein the at least one standard hierarchy assigns node identifiers using a notation that includes a root-level identifier and delimiter-separated level segments, and wherein the notation supports expansion to additional levels and additional nodes at a given level without structural redesign of the at least one standard hierarchy.

9. The system of claim 1, wherein each hierarchy data structure is configured to support recursive expansion, such that (i) a vertical expansion adds a new child level to an existing level and (ii) a horizontal expansion adds a new node instance to an existing level, and wherein said expansion occurs dynamically without requiring modification to the requirement rules.

10. The system of claim 1, wherein at least one requirement rule comprises a conjunction including a first node membership condition referencing a node identifier of a first hierarchy data structure and a second node membership condition referencing a node identifier of a second hierarchy data structure, such that the associated requirement is applicable only when both node membership conditions are satisfied.

11. The system of claim 1, wherein at least one requirement rule comprises a disjunction including node membership conditions referencing node identifiers from at least two different hierarchy data structures, such that the associated requirement is applicable when any of the node membership conditions is satisfied.

12. The system of claim 6, wherein at least one requirement rule comprises nested logical operators combining node membership conditions that reference (i) at least one node identifier of the organizational hierarchy, (ii) at least one node identifier of the at least one standard hierarchy, and (iii) at least one node identifier of the control hierarchy, such that the associated requirement is applicable only when all three node membership conditions are simultaneously satisfied.

13. The system of claim 5, wherein the external input comprises at least one of: an equipment failure signal, an environmental hazard detection, a regulatory change notification, or a safety condition alert.

14. The system of claim 5, wherein a change in a stored condition-state value from a first value to a second value causes the system to identify all entity records whose stored node identifiers satisfy a Boolean expression that includes a node membership condition referencing an affected control hierarchy node having the updated stored condition-state value, and to modify the compliance status of each identified entity record.

15. The system of claim 5, wherein the operations further comprise identifying entity records associated with entities that operated within a physical zone mapped to one or more nodes in the hierarchy data structures and associated with an affected control hierarchy node within a defined lookback period, and designating such entity records as out of compliance until completion of at least one specified remediation requirement.

16. The system of claim 5, wherein the operations further comprise, responsive to the updated stored condition-state value, automatically designating supervisors of entities assigned to a zone associated with the affected control hierarchy node as requiring a refresher requirement, in addition to designating the entities themselves.

17. The system of claim 1, wherein at least one requirement rule is assigned to a parent node of a hierarchy data structure and is applicable to descendant nodes of the parent node, such that entity records associated with a descendant node are subject to the associated requirement without separate assignment to each descendant node.

18. The system of claim 17, wherein, responsive to adding a new child node under the parent node, the new child node inherits applicability of the requirement rule, and the system evaluates the inherited applicability against entity records to identify newly applicable requirements without manual intervention.

19. The system of claim 2, further comprising a reporting engine configured to generate a compliance matrix, the operations further comprising:
(a) receiving a first node-based filter criterion selecting a subset of entity records by specifying node criteria across one or more of the plurality of hierarchy data structures;
(b) receiving a second node-based filter criterion, independent of the first node-based filter criterion, selecting a subset of requirement objects by specifying node criteria across one or more of the plurality of hierarchy data structures; and
(c) generating the compliance matrix by intersecting the subset of entity records with the subset of requirement objects and, for each intersection, determining and outputting a compliance status.

20. The system of claim 6, wherein:
(a) at least one hierarchy data structure is scoped to a specific facility within a multi-facility organization such that nodes and node structures of the scoped hierarchy data structure are independently configurable for each facility;
(b) the system maintains a plurality of standard hierarchies scoped to different regulatory jurisdictions; and
(c) responsive to a regulatory jurisdiction enacting a new regulatory requirement, the system incorporates the new requirement as a new node under an existing jurisdiction-scoped standard hierarchy, and the new node inherits existing requirement rules from its parent node, causing the system to automatically identify entity records in that jurisdiction that are subject to the new regulatory requirement.
